(19) United States
(12) Patent Application Publication
(10) Pub. No.: US 2012/0059694 A1
(43) Pub. Date: Mar. 8, 2012

(54) FUEL DISPENSER APPLICATION FRAMEWORK

(76) Inventors: Brian D. Kuebert, Oak Ridge, NC (US); Danny McCorquodale, Kernersville, NC (US); Shawn Barber, Roaring Spring, NY (US)

(21) Appl. No.: 13/197,440

(22) Filed: Aug. 3, 2011

Related U.S. Application Data
(60) Provisional application No. 61/370,302, filed on Aug. 3, 2010.

(51) Int. Cl. G06Q 20/20; G06Q 30/02

(52) U.S. Cl. 705/14.4; 705/18

(57) ABSTRACT

A fuel dispenser utilizing an application framework that comprises at least two portions, the first of which is configured to communicate with all devices, including those that handle confidential or sensitive customer data, while the second portion is configured to communicate only with devices that do not handle confidential or sensitive data. The application framework also comprises two frame buffers, one of which is only accessible by the first, secure portion. Additionally, the first portion determines which frame buffer is used by a display module to transmit data to a display in order to present a graphical representation of the data.

### CROSS-REFERENCE TO RELATED APPLICATIONS

The present application claims the benefit of U.S. patent application No. 61/370,302, entitled “Fuel Dispenser Application Framework” and filed on Aug. 3, 2010, the entire disclosure of which is hereby incorporated by reference as if set forth verbatim herein and relied upon for all purposes.

### FIELD OF THE INVENTION

The present invention relates to fuel dispensers. More particularly, the present invention relates to a fuel dispenser having a novel application framework for its user interface.

### BACKGROUND OF THE INVENTION

Payment terminals include components that allow a customer to pay for the goods or services offered by the retail device associated with the payment terminal. For instance, payment terminals have been incorporated into fuel dispensers in order to allow a customer to pay for any dispensed fuel.

Background information and examples of fuel dispensers and retail fueling environments are provided in U.S. Pat. Nos. 5,689,071 (entitled “Wide Range, High Accuracy Flow Meter”), 5,734,851 (entitled “Multimedia Video/Graphics in Fuel Dispensers”), 5,956,259 (entitled “Intelligent Fueling”), 6,052,629 (entitled “Internet Capable Browser Dispenser Architecture”), 6,453,204 (entitled “Fuel Dispensing System”), 6,935,191 (entitled “Fuel Dispenser Fuel Flow Meter Device, System and Method”), 7,280,087 (entitled “Multiple Browser Interface”), and 7,289,877 (entitled “Fuel Dispensing System for Cash Customers”), all of which are hereby incorporated by reference as if set forth verbatim herein.

The payment terminal of modern fuel dispensers typically includes a display configured to present information to a customer. The payment terminal is connected to a point-of-sale system (“POS”), which selects what information the payment terminal, and thus the fuel dispenser, presents to the customer. Usually, the provider of the POS determines what information associated with the fueling process is selected for presentation. It is more difficult to manage information and other material to be presented to the customer that is provided by entities other than the POS system's manufacturer or by the owner or operator of the fueling environment.

### SUMMARY OF THE INVENTION

The present invention recognizes and addresses the foregoing considerations, and others, of prior art construction and methods.

In this regard, one aspect of the present invention provides a fuel dispenser comprising a valve, a processing device, a user interface, and memory. The valve is configured to facilitate a release of fuel by the fuel dispenser. The processing device is operatively connected to the valve. The user interface comprises at least one input device and a display, and the processing device is operatively connected to the at least one input device and the display. The memory is operatively connected to the processing device and comprises an application framework that defines at least first and second frame buffers and includes a general purpose application and a secure payment application. The application framework provides both the general purpose application and the secure payment application with access to the first frame buffer but prevents the general purpose application from accessing the second frame buffer. The secure payment application determines which of the first and second frame buffers may be used to present information via the display.

Another aspect of the present invention provides a payment terminal comprising a display, memory, and a processing device operatively connected to the display and the memory. The memory comprises an application framework that includes a plurality of applications, a plurality of modules, and a plurality of frame buffers. Each of the frame buffers is configured to store information to be presented by the display. When the application framework is executed by the processing device, it provides a first of the plurality of applications with access to the plurality of modules and the plurality of frame buffers, provides a second of the plurality of applications with access to a first set of the plurality of modules and a first set of the plurality of frame buffers, and prevents the second application from accessing a second set of the plurality of modules and a second set of the plurality of frame buffers.

Yet another aspect of the present invention provides an application framework for a payment terminal that comprises a display, memory, and a processing device. The processing device is operatively connected to the display and the memory. The application framework is stored on the memory and comprises a general purpose application, a secure payment application, at least one input module configured to handle communication with at least one input device, a first frame buffer, and a second frame buffer. Each of the frame buffers is configured to store information to be presented by the display. When executed by the processing device, the application framework is configured to cause the payment terminal to provide both the general purpose application and the secure payment application with access to the first frame buffer, prevent the general purpose application from accessing the second frame buffer, and provide the secure payment application with the ability to determine which of the first and second frame buffers is used by the display.

The accompanying drawings, which are incorporated in and constitute a part of this specification, illustrate one or more embodiments of the present invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a partially schematic, perspective view of a fuel dispenser in accordance with an embodiment of the present invention;

FIG. 2 is a schematic representation of an application framework of the fuel dispenser of FIG. 1; and

FIG. 3 is a flowchart illustrating an exemplary use of the application framework of FIG. 2.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

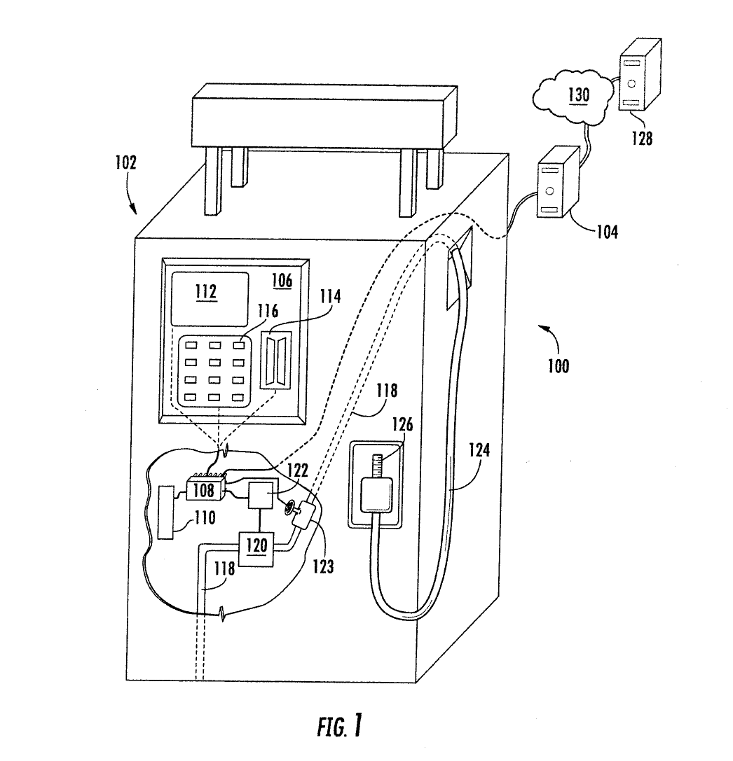

FIG. 1 illustrates a retail environment comprising a payment terminal operatively connected to a point-of-sale system (“POS”). In this embodiment, the retail environment corresponds to a fueling environment 100, the payment terminal comprises a fuel dispenser 102, and the POS system comprises a site controller 104. While FIG. 1 illustrates a single fuel dispenser 102 being operatively connected to site controller 104, it should be understood that fueling environment 100 may include multiple fuel dispensers, each being operatively connected to the site controller, as well as other structures, such as a convenience store and a carwash.

Fuel dispenser 102 comprises a user interface 106, a processing device 108, and memory 110. User interface 106 includes a display 112, a card reader 114, and a numeric pad 116. Processing device 108 is operatively connected to memory 110, as well as the components of user interface 106, including display 112, card reader 114, and numeric pad 116. In the presently-described embodiment, card reader 114 is a magnetic strip card reader, but it should be understood that card reader 114 may be any suitable card reader, including a magnetic strip card reader, a smart card reader, a contactless card reader, or any combination thereof. User interface 106 may comprise other components operatively connected to processing device 108, such as a cash acceptor, other payment-accepting devices, a barcode scanner, a radio frequency (“RF”) device reader, a receipt printer, a camera, or other components, as should be understood in the art and as described in more detail below.

As should also be understood by those skilled in the art, fuel dispenser 102 additionally comprises various components configured to facilitate the delivery of fuel to a vehicle. For instance, fuel dispenser 102 comprises a piping network 118 in fluid communication with at least one underground storage tank (“UST”), a meter 120, a pulser 122, a valve 123, a hose 124, and a nozzle 126. Processing device 108 may be operatively connected to one or more of these components, such as pulser 122 and valve 123, in order to control their operation and to manage the delivery of fuel by fuel dispenser 102.

Processing device 108 may be a processor, microprocessor, controller, microcontroller, other appropriate circuitry, or any combination thereof. For example, multiple electronic devices including several microcontrollers configured to operate together within fuel dispenser 102 may be considered a “processing device.” Memory 110 may be any suitable type of memory or computer-readable medium that is capable of being accessed by processing device 108. For instance, memory 110 may be random access memory (“RAM”), read-only memory (“ROM”), erasable programmable ROM (“EPROM”) or electrically EPROM (“EEPROM”), CD-ROM, DVD, or other optical disk storage, solid state drive (“SSD”), magnetic disk storage, including floppy or hard drives, any type of non-volatile memories, such as secure digital (“SD”), flash memory, memory stick, or any other medium that may be used to carry or store computer program code in the form of computer-executable programs, instructions, or data. Processing device 108 may also include a portion of memory accessible only to the processing device, commonly referred to as “cache.” Thus, memory 110 may be part of processing device 108, may be separate, or may be split between the relevant processing device and one or more separate memory devices.

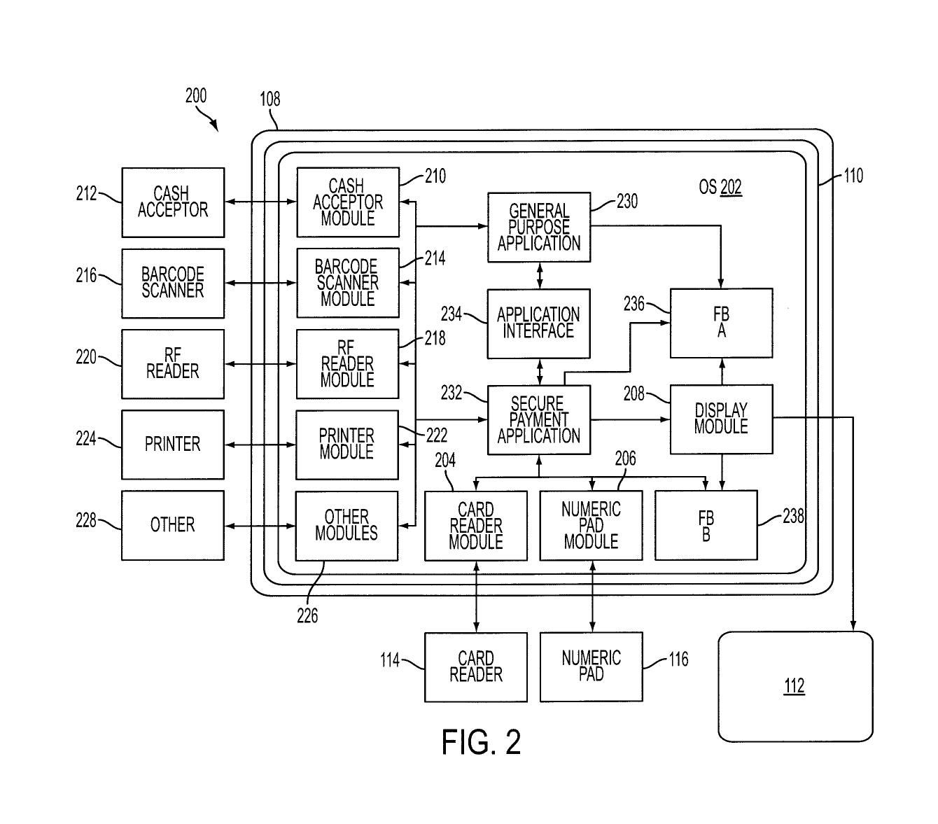

Memory 110 comprises computer-executable program code or instructions that, when executed by processing device 108, perform at least a portion of the processes described in more detail below. Memory 110 may also comprise one or more data structures for storing information, such as a database or a table. The computer-executable program code or instructions in this scenario, as should be known to those skilled in the art, usually include one or more application programs, other program modules, program data, firmware, and/or an operating system, as explained in more detail below with reference to FIG. 2.

In the presently-described embodiment, processing device 108 is operatively connected to site controller 104. In this embodiment, fueling environment 100 is configured such that fuel dispenser 102 may be operatively connected to a wide area network (“WAN”) 130, such as the Internet. It should be understood, however, that fuel dispenser 102 may be connected either directly to WAN 130 or indirectly via additional components located within fueling environment 100, which may include site controller 104 as illustrated. An example of another suitable configuration is set forth in copending U.S. patent application Ser. No. 12/689,983 (entitled “Payment Processing System for Use in a Retail Environment Having Segmented Architecture” and filed on Jan. 19, 2010), the entire disclosure of which is hereby incorporated by reference as if set forth verbatim herein and relied upon for all purposes. It should also be understood that other resources, such as a server 128, is operatively connected and accessible to fueling environment 100 via WAN 130.

User interface 106 may be configured to facilitate the dispensing of fuel and the acceptance of payment for the dispensed fuel, as well as to provide other information to customers. For instance, display 112 is configured to provide instructions to a customer regarding the fueling process, while card reader 114 and numeric pad 116 are configured to accept payment card information provided by the customer. That is, card reader 114 is configured to receive payment card data from a magnetic strip card, such as a credit or debit card, that is swiped or inserted into the card reader. Numeric pad 116 is configured to receive information from a customer associated with the swiped card, such as a personal identification number (“PIN”) of a debit card or the billing postal (zip) code of a credit card.

Examples of fuel dispenser user interfaces may be found in copending patent application Ser. Nos. 12/464,092 (entitled “Internet Capable Browser Dispenser Architecture” and filed on May 11, 2009), 12/695,692 (entitled “Virtual PIN Pad for Fuel Payment Systems” and filed on Jan. 28, 2010), and 12/797,094 (entitled “Fuel Dispenser User Interface” and filed on Jun. 9, 2010), the entire disclosure of each of which is hereby incorporated by reference as if set forth verbatim herein and relied upon for all purposes.

As noted above, user interface 106 may include other devices configured to facilitate financial transactions for payment of the dispensed fuel. For instance, a smart card reader may be provided to handle transactions involving the use of smart cards, while a cash acceptor may be provided to handle transactions involving cash payments. A receipt printer, if provided, will print a receipt upon completion of a fueling process. Processing device 108 is configured to handle the communication and processing of all data transmitted to and received from the components of user interface 106, as explained in more detail below.

In operation, a customer positions his vehicle adjacent to fuel dispenser 102 to initiate the fueling process. Display 112 presents instructions to the customer as to the manner by which to begin the process, which may instruct the customer to swipe or insert a credit or debit card using card reader 114. That is, processing device 108 retrieves data from memory 110 representative of images, text, or a combination of the two that includes the instructions and transmits the data to display 112.

In this example, the customer swipes a debit card using card reader 114 and provides the PIN associated with the debit card to fuel dispenser 102 using numeric pad 116. In order to determine whether to authorize the fueling process, fuel dispenser 102 transmits at least a portion of the payment card data received from the customer to site controller 104. The site controller transmits at least a portion of the data received from fuel dispenser 102 to a server maintained by a financial institution corresponding to the card provided by the customer. Data representative of whether the financial institution authorizes the transaction is returned to site controller 104. The site controller transmits data representative of whether to allow fueling to commence back to fuel dispenser 102, as should be understood in the art.

In certain embodiments, such as those involving legacy fuel dispensers, site controller 104 may be configured to manage the delivery of fuel by the dispenser(s). In an embodiment where fuel dispenser 102 operates so that processing device 108 manages the fueling process, processing device 108 instructs valve 123 to open in order to allow the flow of fuel if authorization has been received from site controller 104. When the customer activates nozzle 126 and valve 123 is open, fuel flows from at least one UST through piping network 118. Meter 120 measures the flow of fuel as it flows through the meter, while pulser 122 transmits a signal to processing device 108 representative of the measurement. In this mode of operation, processing device 108 maintains data corresponding to the fueling process, such as the total volume of fuel dispensed and the total amount corresponding to the dispensed fuel, in memory 110, as should be understood by those skilled in the art. Processing device 108 transmits at least a portion of this data to display 112 during the fueling process for presentation to the customer.

Upon completion of the fueling process, fuel dispenser 102 transmits data to site controller 104, which transmits data to the financial institution, corresponding to the completed fueling process in order to finalize the transaction. The financial institution performs any necessary tasks which may include debiting the customer's account, as is well-known in the art, and may return data to site controller 104 indicative of the same. Additionally, fuel dispenser 102 may complete any ancillary tasks associated with the fueling process, such as printing a receipt for the customer if desired. Display 112 may be configured to display the final values, such as a total volume of fuel dispensed and a total dollar amount corresponding to the dispensed fuel.

FIG. 2 is a schematic representation of an application framework 200 in accordance with an embodiment of the present invention. In the presently-described embodiment, memory 110 is included within processing device 108 as illustrated. It should be understood, however, that memory 110 may be one or more components separate from, and managed by, processing device 108, as explained above.

Memory 110 comprises an operating system (“OS”) 202. In this embodiment, operating system 202 is version 9.04 of the Linux distribution entitled Ubuntu, which is maintained by the Ubuntu Foundation of Canonical Limited, headquartered in London, United Kingdom. Those skilled in the art should appreciate that other versions of Ubuntu, other distributions of Linux, and other operating systems may be used without departing from the scope of the present invention.

Operating system 202 comprises program code or computer instructions configured to communicate with devices external to the operating system via ports, such as an RS-232 serial port or a universal serial bus (“USB”). That is, each external device may be operatively connected to processing device 108 via such a port. Operating system 202 includes a driver for each port that allows applications executed by the operating system to communicate via these ports, as should be understood by those skilled in the art.

In this embodiment, operating system 202 also comprises program code or computer instructions that make up a module, applet, driver, or other program for each external device operatively connected to processing device 108 that allow the programs or applications executed on operating system 202 to communicate with each external device. It should be understood that the terms module, applet, driver, and program, as used in this scenario for software that facilitates communication between an OS and an external device, should be construed to be interchangeable. Accordingly, the following explanation refers to such software as “modules.” For example, operating system 202 comprises a card reader module 204 configured to communicate with card reader 114, a numeric pad module 206 configured to communicate with numeric pad 116, and a display module 208 configured to communicate with display 112. Operating system 202 may comprise additional similar modules configured to communicate with any other devices operatively connected to processing device 108. For instance, operating system 202 may comprise a cash acceptor module 210 configured to communicate with a cash accepter 212, a barcode scanner module 214 configured to communicate with a barcode scanner 216, a radio frequency (“RF”) module 218 configured to communicate with an RF reader 220, and a printer module 222 configured to communicate with a printer 224, such as the receipt printer described above. Operating system 202 may also comprise additional modules 226 to communicate with any other external devices 228. For instance, modules 226 may include a module that communicates with the components of the fuel dispenser that facilitate the delivery of fuel, such as valve 123 (FIG. 1).

Operating system 202 also includes one or more applications, programs, or other software capable of being executed by processing device 108. In the presently-described embodiment, operating system 202 comprises a general purpose application 230 and a secure payment application 232. In the presently-described embodiment where the retail device utilizing application framework 200 is a fuel dispenser, general purpose application 230 may be any application configured to handle the operations of the dispenser that does not involve sensitive or confidential information. For instance, general purpose application 230 is configured to manage the components of the fuel dispenser used to deliver fuel to a vehicle, as should be understood by those skilled in the art. In comparison, secure payment application 232 is any application that is tasked with handling sensitive or confidential information. In this particular arrangement, general purpose application 230 transmits a request to secure payment application 232 when the general purpose application requires the secure payment application to process sensitive or confidential information, as described in more detail below.

In one embodiment, a secure payment application interface 234 provides the means by which general purpose application 230 may communicate with secure payment application 232 if desired. It should be understood that the specific configuration of application framework 200 as illustrated in FIG. 2 may be altered as desired yet still provide the functionality and processes described below without departing from the scope of the present invention. As described in the ensuing explanation, for instance, application framework 200 may include additional modules and applications, or the modules included in the framework may be arranged in a manner different than that illustrated in FIG. 2 in order to only communicate with certain predefined applications.

Additional information and examples of other hardware configurations may be found in European Published Patent Application No. 1,408,459 (entitled “Secure Controller of Outdoor Payment Terminals in Compliance with EMV Specifications” and published on Apr. 14, 2004), U.S. Pat. No. 7,607,576 (entitled “Local Zone Security Architecture for Retail Environments” and issued on Oct. 27, 2009), and U.S. Published Patent Application Nos. US 2008/0120191 (entitled “Remote Display Tamper Detection Using Data Integrity Operations” and published on May 22, 2008) and 2009/0265638 (entitled “System and Method for Controlling Secure Content and Non-Secure Content at a Fuel Dispenser or Other Retail Device” and published on Oct. 22, 2009), the entire disclosure of each of which is hereby incorporated by reference as if set forth verbatim herein and relied upon for all purposes.

In the presently-described embodiment, operating system 202 includes at least two frame buffers 236 and 238 (also shown as “FB A” and “FB B”) configured to store content to be presented by display 112. As should be understood, a buffer is a section of memory 110 reserved for temporary storage of data waiting to be directed to a device. In this case, frame buffers 236 and 238 are portions of memory 110 that store data to be written to display 112 and are accessible to display module 208. That is, display module 208 retrieves data stored in frame buffer 236 or 238 and transmits it to display 112 in order to present graphical representation of the data as described in more detail below. In one embodiment, each of frame buffers 236 and 238 is a graphic hardware-independent abstraction layer of operating system 202 using a portion of memory 110 to present graphics on display 112.

Application framework 200 is configured so that general purpose application 230 and secure payment application 232 are able to communicate with modules 210, 214, 218, 222, and 226, as well as frame buffer 236. Application framework 200 is also configured in a manner that allows secure payment application 232 to communicate with modules 204, 206, and 208, as well as frame buffer 238. As a result, only secure payment application 232 is able to communicate with display 112, card reader 114, and numeric pad 116. That is, general purpose application 230 (and any other application installed on operating system 202) is not able to communicate directly with modules 204, 206, and 208, and thus with card reader 114, numeric pad 116, or display 112 but may do so indirectly by communicating with secure payment application 232. It should be understood that secure payment application 232 effects the selection of which frame buffers 236 and 238 that display 112 may access via display module 208. Thus, other applications may store data in frame buffer 236 in order to present information to display 112 via display module 208, but secure payment application 232 determines which frame buffer the display module uses at any given instance. It should therefore be appreciated that any other application is unable to transmit data directly to display 112 via display module 208 without secure payment application 232 instructing display module 208 to use frame buffer 236. In the illustrated embodiment, application framework 200 provides secure payment application 232 with direct access to frame buffer 236 should the secure payment application need to erase or otherwise clear the content stored in frame buffer 236 for any reason.

General purpose application 230, as well as any other applications installed on operating system 202, is also unable to access frame buffer 238. This is accomplished inherently by the design of application framework 200 in that no direct communication paths exist between general purpose application 230 and modules 204, 206, and 208 or between the general purpose application and frame buffer 238. It should be understood that other means of access control that prevent general purpose application 230 and applications executed on operating system 202 other than secure payment application 232 from accessing certain modules, as well as frame buffer 238 or other selected portions of memory 108, may be utilized without departing from the scope of the present invention.

For instance, policies and permissions may be set for modules 204, 206, and 208 and frame buffer 238 that only allow these modules and the frame buffer to communicate with secure payment application 232. Alternatively, operating system 202 may be configured to include the security-enhanced Linux (“SELinux”) feature developed by the U.S. National Security Agency. In such an embodiment, modules 204, 206, and 208, frame buffer 238, and secure payment application 232 are installed on the SELinux portion of operating system 202 for enhanced security. It should be understood that in such an embodiment, the other applications and modules are installed on the non-SELinux portion and communicate with modules 204, 206, and 208 via secure payment application 232 in a manner similar to that described above. Communication with the secure payment application may be accomplished directly or indirectly via application interface 234.

In operation, processing device 108 initiates operating system 202 stored in memory 110. Operating system 202 then executes applications and programs stored in memory 110, such as general purpose application 230 and secure payment application 232. Additionally, modules 204, 206, 208, 210, 214, 218, 222, and any other modules 226 are initialized. In one embodiment, secure payment application 232 directs display module 208 to instruct display 112 to present information via the display representative of any data stored in or written to frame buffer 236. General purpose application 230 writes data to frame buffer 236 representative of a welcome screen or advertisement. Display module 208 transmits the data to display 112, which displays the screen corresponding to the data.

Processing device 108, operating system 202, and the programs initiated therein are configured to handle the receipt of data from any external device included within user interface 106. For instance, card reader 114 is configured to transmit payment card data to module 204 that the card reader receives when a customer swipes a card through the reader. Card reader module 204 receives the data and, in one embodiment, automatically transmits the data to secure payment application 232. In another embodiment, card reader module 204 stores the payment card data until secure payment application 232 requests it. Likewise, numeric pad 116 transmits data to module 206 representative of any numeric keys that are selected by a customer. The data may be stored by module 206 until requested or automatically transmitted to secure payment application 232.

Cash acceptor 212 transmits data to cash acceptor module 210 of any currency it receives. Barcode scanner 216 transmits data to barcode scanner module 214 representative of any barcode scanned. RF reader 220 transmits data to RF reader module 218 corresponding to any RF signals received by the reader. For instance, a customer may provide a loyalty card bearing a barcode or another device having an RF identification (“RFID”) tag to barcode scanner 216 or RF reader 220, respectively. Any data received from the barcode or RFID tag are transmitted to module 214 or 218, respectively. Data representative of any information received from other devices 228 is transmitted to one of the other modules 226 corresponding to the device that receives the information. In one embodiment, modules other than those handling sensitive data or confidential information may be configured to automatically transmit any data they receive to general purpose application 230 and/or secure payment application 232. In another embodiment, each module stores the data until general purpose application 230 or secure payment application 232 requests it.

Any sensitive or confidential payment information is handled by secure payment application 232. That is, any sensitive information received from card reader 114, such as payment card data, or from numeric pad 116, such as a customer's PIN, can only be transmitted to and is handled by secure payment application 232. Any other program executed on operating system 202, such as general purpose application 230, is unable to access such data unless granted access by the secure payment application. Accordingly, it should be understood that the sensitive or confidential information is maintained within a secure portion of operating system 202 and of fuel dispenser 102.

In one example, for instance, a customer swipes a magnetic strip card through card reader 114. The card reader transmits the payment card data received from the card to card reader module 204, which transmits the data to secure payment application 232. In this example, secure payment application 232 instructs display module 208 not to retrieve any data from frame buffer 236 but, instead, to only retrieve data from frame buffer 238 in order for display 112 to present graphical information. Secure payment application 232 transmits data to frame buffer 238 representative of a graphical user interface (“GUI”) asking the customer to provide his PIN or postal code using numeric pad 116. Numeric pad 116 transmits data representative of the keys selected by the customer to numeric pad module 206, which transmits the data to secure payment application 232.

Processing device 108 and, specifically, secure payment application 232 may transmit the payment card data and the data representative of the numeric keys selected by the customer to a POS, such as site controller 104 (FIG. 1). The POS may transmit at least a portion of the data to a server associated with the financial institution that issued the magnetic strip card provided by the customer, in a manner similar to that described above with respect to FIG. 1. This allows processing device 108 and, more specifically, secure payment application 232 to receive an indication of whether the customer is authorized to dispense fuel or to finalize the customer's payment for any fuel dispensed. Display module 208 continues to instruct display 112 to present graphical information defined by the data stored in frame buffer 238, and does not retrieve data from frame buffer 236 until and unless instructed by secure payment application 232 to do so.

General purpose application 230 performs various other functions, such as, for example, associating a customer's loyalty account with a fueling transaction. For instance, general purpose application 230 stores data in frame buffer 236 representative of a GUI instructing the customer to scan the barcode that appears on the customer's loyalty program card. General purpose application 230 transmits data to secure payment application 232 via application interface 234 that the general purpose application seeks to present graphical information via display 112. Should secure payment application 232 determine general purpose application 230 should be able to use display 112 at this point, it instructs display module 208 to use frame buffer 236. Display module 208 retrieves the data representative of the GUI from frame buffer 236 and transmits it to display 112. Secure payment application 232 concurrently instructs display module 208 not to retrieve data or other information from frame buffer 238. That is, display module 208 selects which frame buffer will be used by the display, where the determination of the selection is controlled by secure payment application 232.

In one embodiment, when secure payment application 232 instructs display module 208 to retrieve data from frame buffer 236 and to not retrieve data from frame buffer 238, it also instructs card reader module 204 and numeric pad module 206 to disable card reader 114 and numeric pad 116, respectively. Alternatively, secure payment application 232 instructs modules 204 and 206 to ignore any input from card reader 114 and numeric pad 116, respectively, when display module 208 is using frame buffer 236 to provide data to display 112. Regardless, it should be understood that the customer cannot provide confidential or sensitive information to processing device 108 in such an embodiment during a timeframe when secure payment application 232 instructs display module 208 to access frame buffer 236 rather than frame buffer 238. In another embodiment, display 112 includes a notification or other indication that signifies which of frame buffers 236 and 238 is in use. For instance, display 112 may present an icon or label indicating that the system is in a secure mode when frame buffer 238 is in use and an icon or label indicating that the system is an open mode when frame buffer 236 is in use.

Continuing with the above example, barcode scanner 216 transmits information received from the customer's loyalty program card to barcode scanner module 214, which transmits the information to general purpose application 230. General purpose application 230 may use information received from the external devices including barcode scanner 216, such as by writing data representative of the information received from the customer's loyalty card to frame buffer 236. Display module 208 then transmits the data to display 112, which presents a GUI that includes the information from the customer's account. Alternatively, general purpose application 230 may provide the information regarding the customer's loyalty program account to secure payment application 232 by interacting with application interface 234. Secure payment application 232 may associate the loyalty program information with information regarding an ongoing fueling process performed by the customer.

When a fueling transaction is complete, secure payment application 232 facilitates the completion of the transaction in a manner similar to that described above with respect to FIG. 1. In one embodiment, secure payment application 232 transmits non-confidential and non-sensitive information regarding the transaction to general purpose application 230 via application interface 234. For example, this may include a confirmation number associated with the transaction provided by the POS system, such as by site controller 104 (FIG. 1). General purpose application 230 may use this information to carry out ancillary tasks, such as creating a receipt associated with the completed transaction or associating the transaction with the customer's loyalty account, if desired. General purpose application 230 transmits data representative of the receipt to printer module 222. Printer module 222 instructs printer 224 to print the receipt based on the data received from printer module 222.

Referring additionally to FIG. 1, processing device 108 is operatively connected to other resources that are connected to WAN 130, such as the POS or server 128, as described above. General purpose application 230 is configured to communicate with the POS or server 128 in order to receive material from either, such as advertisements or promotions. In one embodiment, the POS comprises a system for facilitating the delivery of advertisements to fueling environment 100, an example of which is the APPLAUSE system provided by Gilbarco Inc. of Greensboro, N.C. In such an embodiment, the advertisement material stored by the APPLAUSE system and served to other systems is associated with a uniform resource locator (“URL”). General purpose application 230 includes a hypertext markup language (“HTML”) compliant browser that the application directs to the APPLAUSE system using the URL. General purpose application 230 stores the material received by the browser in frame buffer 236.

At a predetermined time as explained in more detail below, secure payment application 232 instructs display module 208 to use frame buffer 236 rather than frame buffer 238. Secure payment application 232 may concurrently instruct modules 204 and 206 to ignore input from card reader 114 and numeric pad 116, respectively, as well as any other selected devices operatively connected to processing device 108, in a manner similar to that described above. Display module 208 retrieves the data from frame buffer 236 corresponding to the material provided by the APPLAUSE system and instructs display 112 to present a graphical representation of the material. As a result, fuel dispenser 102 may present advertisements provided by the POS while preventing access to any secure, confidential, or sensitive data and to specific devices, but while allowing access to certain other devices, such as display 112 via frame buffer 236.

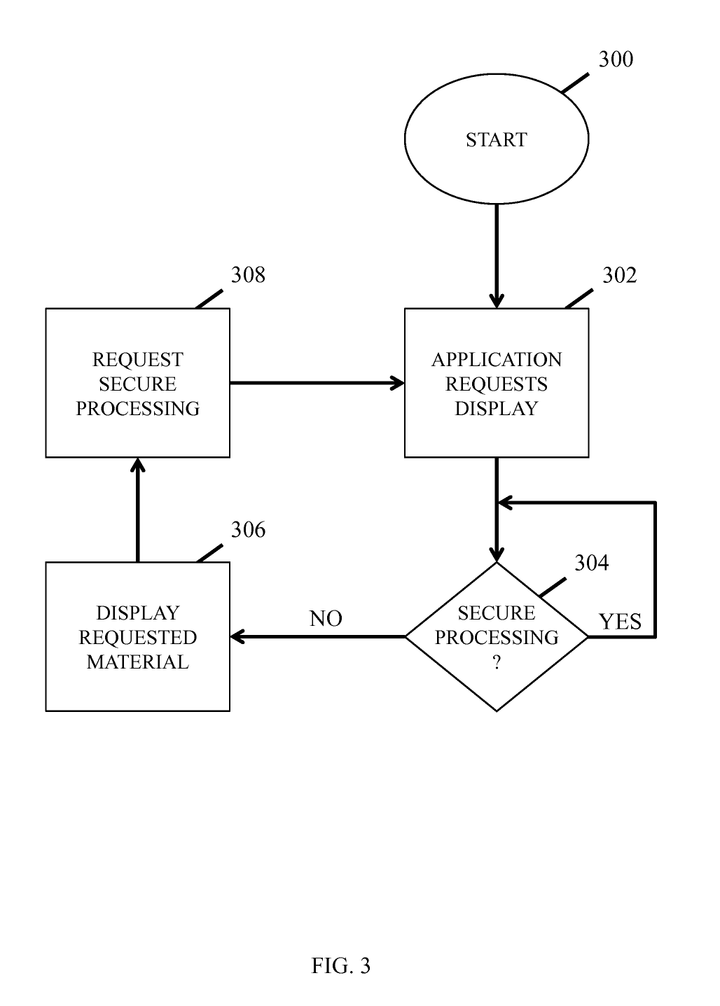

In another embodiment, general purpose application 230 requests material including advertisements from one or more external sources, such as server 128. This may be accomplished in the manner described above by directing a browser within general purpose application 230 to a URL associated with the requested material stored on server 128. Alternatively, this may be accomplished through the use of a communication socket operatively connected to application framework 200. In such an embodiment, the socket is associated with a module included within application framework 200, such as other modules 226, that handles receipt of the material received via the socket from the external source. The use of sockets to request and receive information should otherwise be understood by those skilled in the art and is therefore not described in further detail. Once received by general purpose application 230, the material is stored in frame buffer 236 and the general purpose application transmits a request via application interface 234 to secure payment application 232 to display the material. Process flow then proceeds in a manner similar to that described above and as explained in more detail below with regard to FIG. 3. As a result, fuel dispenser 102 may present advertisements provided by third parties while preventing access to any secure, confidential, or sensitive data and to specific devices, but while allowing access to certain other devices, such as display 112 via frame buffer 236.

It should be understood that the above description provides an application framework for a payment terminal that only allows certain secure applications, portions of an operating system, and portions of a payment system to access particular devices, such as a payment card reader and a numeric pad. Access to these particular devices must be accomplished via the secure application. Thus, application framework 200 separates a secure portion of a payment system from an open portion. The payment system additionally defines at least two frame buffers used to store data to be written to an associated display. The application framework allows the secure application to control which frame buffer is currently being used to transmit data to the display. The framework is configured so that only the secure portion of the system or the secure application may access one of the frame buffers. The other frame buffer may be accessed by any of the applications installed and running on the operating system or by external resources.

While FIG. 2 presents a specific configuration of modules, it should be understood that other applications, devices, and modules may be added as desired. While general purpose application 230 and secure payment application 232 are illustrated as single applications, for instance, each may include a set of applications configured to perform different tasks. It should be understood, however, that, while the applications included within secure payment application 232 may access frame buffer 238, the applications included within general purpose application 230 may not.

It should also be understood that the configuration of modules may be altered so that certain modules may only communicate with the secure payment application, similar to modules 204, 206, and 208. For instance, if fuel dispenser 102 is configured to receive payment information from RF cards or tokens, module 218 may be configured to communicate with secure payment application 232 only rather than both the secure payment application and general purpose application 230. Those skilled in the art should appreciate that the general purpose application may continue to communicate with RF reader 220 via module 218, but the communication in this embodiment is accomplished via secure payment application 232, which acts as a gateway to prohibit dissemination of any sensitive or confidential information to non-secure components, such as the general purpose application. In this scenario, that is, only secure payment application 232 is configured to communicate directly with RF reader module 218 because RF reader 220 may receive sensitive or confidential information. RF reader 220 may also be configured to receive information that is not considered to be sensitive, such as a customer's loyalty program account number. Nonetheless, because RF reader 220 is configured to potentially receive payment information, general purpose application 230 must request any non-sensitive information received by the RF reader from secure payment application 232. Regardless, it should be understood that devices configured to handle secure, sensitive, or confidential data communicate only with the secure payment application, which also controls what the fuel dispenser displays by controlling which frame buffer is used by display module 208 at any given time.

Secure payment application 232 determines whether to instruct display module 208 to use frame buffer 236 or frame buffer 238 as described above. In one embodiment, the determination is based on a set of rules stored within the secure payment application and varies depending upon the purpose and use of the retail device that incorporates application framework 200. In an embodiment where the retail device is a fuel dispenser, for example, secure payment application 232 comprises a set of rules that determine when non-secure content may be presented by the dispenser, as should be understood by those skilled in the art. Thus, the rules set forth the manner by which secure payment application 232 determines when to instruct display module 208 to use frame buffer 236 and when to instruct the display module to use frame buffer 238.

FIG. 3 is a flowchart illustrating an exemplary process for determining when to use the frame buffer configured to handle secure or confidential information and when to use the frame buffer that is not configured to, as described above. Referring to FIGS. 2 and 3, the process begins at step 300, where processing device 108 initializes application framework 200. This may include initiating OS 202, allocating memory to frame buffers 236 and 238, and setting the permissions for each frame buffer so that only secure payment application 232 may write data to frame buffer 238, for instance. Process flow then proceeds to step 302 where general purpose application 230 transmits a request to secure payment application 232 to display the information stored within frame buffer 236. At step 304, secure payment application 232 determines whether any sensitive or confidential information is being processed. If so, secure payment application 232 does not instruct display module 208 to use frame buffer 236, and the process flow loops back to step 304. Once secure payment application 232 determines that any secure processing has concluded or if no sensitive or confidential information was being processed at step 304, process flow proceeds to step 306. Here, secure payment application 232 determines whether to accept the request received from general purpose application 230 and, if so, instructs display module 208 to use frame buffer 236 instead of frame buffer 238. As noted above, this decision may be based on a set of rules stored within and used by the secure payment application. As a result, the material stored in frame buffer 236 is presented via display 112. Secure payment application 232 may perform any ancillary tasks as explained above or as understood in the art. For instance, secure payment application 232 may disable card reader 114 and/or numeric pad 116 via card reader module 204 and numeric pad module 206, respectively.

Process flow continues until secure payment application 232 receives a request to process sensitive or confidential information at step 308. Secure payment application 232 may receive the request from general purpose application 234 when, for example, the general purpose application has requested payment information from a customer for fuel provided by the dispenser, as should be understood by those skilled in the art. At step 308, secure payment application 232 instructs display module 208 to use frame buffer 238 as opposed to frame buffer 236. Secure payment application 232 performs any ancillary tasks at step 308 as explained above or as understood in the art, such as processing payment information received from card reader module 204 and numeric pad module 206. Process flow then continues until secure payment application 232 receives a request to display information from general purpose application 230 at step 302 and then continues in the manner described above.

While one or more preferred embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made. Therefore, it is contemplated that any and all such embodiments are included in the present invention as may fall within the scope and spirit thereof. For instance, the above disclosure describes a fuel dispenser in a fueling environment, but it should be understood that aspects of the present invention may be applied to any other suitable payment terminal operating in any retail environment.

What is claimed is:

1. A fuel dispenser comprising:
a valve configured to facilitate a release of fuel by the fuel dispenser;
a processing device operatively connected to the valve;
a user interface comprising at least one input device and a display, wherein the processing device is operatively connected to the at least one input device and the display; and
memory operatively connected to the processing device and comprising an application framework that defines at least first and second frame buffers and includes a general purpose application and a secure payment application, wherein the application framework provides both the general purpose application and the secure payment application with access to the first frame buffer but prevents the general purpose application from accessing the second frame buffer and the secure payment application determines which of the first and second frame buffers may be used to present information via the display.

2. The fuel dispenser of claim 1 wherein the at least one input device comprises a first input device configured to receive payment information from a customer of the fuel dispenser, the application framework includes a first input device module configured to handle communication with the first input device, and the application framework prevents the general purpose application from accessing the first input device module directly but provides the secure payment application with access to the first input device module.

3. The fuel dispenser of claim 2 wherein the at least one input device comprises a second input device configured to receive non-confidential information from the customer, the application framework includes a second input device module configured to handle communication with the second input device, and the application framework provides both the general purpose application and the secure payment application with access to the second input device module.

4. The fuel dispenser of claim 1 wherein the application framework includes a display module operatively connected to the first and second frame buffers, to the display, and to the secure payment application, whereby the determination by the secure payment application of which of the first and second frame buffers may be used to present information via the display is effected by the display module.

5. The fuel dispenser of claim 1 wherein the general purpose application writes an advertisement to the first frame buffer.

6. The fuel dispenser of claim 5 wherein the secure payment application directs the display to use the first frame buffer so that the advertisement is presented by the display.

7. The fuel dispenser of claim 5 wherein the fuel dispenser is operatively connected to a server and the general purpose application receives the advertisement from the server.

8. The fuel dispenser of claim 1 wherein the secure payment application is configured to effect payment transactions for fuel dispensed by the fuel dispenser.

9. The fuel dispenser of claim 8 wherein the secure payment application is configured to effect the payment transactions based at least in part on payment information received from the at least one input device.

10. A payment terminal comprising:
a display;
memory; and
a processing device operatively connected to the display and the memory,
wherein the memory comprises an application framework that includes a plurality of applications, a plurality of modules, and a plurality of frame buffers, wherein each of the frame buffers is configured to store information to be presented by the display, and wherein, when executed by the processing device, the application framework provides a first of the plurality of applications with access to the plurality of modules and the plurality of frame buffers, provides a second of the plurality of applications with access to a first set of the plurality of modules and a first set of the plurality of frame buffers, and prevents the second application from accessing a second set of the plurality of modules and a second set of the plurality of frame buffers.

11. The payment terminal of claim 10 wherein the application framework provides the first application with the ability to select which of the frame buffers the display uses to present information.

12. The payment terminal of claim 10 wherein the application framework comprises a secure portion of an operating system and the secure payment application, the second set of the plurality of the modules, and the second set of the plurality of frame buffers is are stored on the secure portion.

13. An application framework for a payment terminal that comprises a display, memory, and a processing device, wherein the processing device is operatively connected to the display and the memory, and wherein the application framework is stored on the memory and comprises:
a general purpose application;
a secure payment application;
at least one input module configured to handle communication with at least one input device; and
a first frame buffer and a second frame buffer, wherein each of the frame buffers is configured to store information to be presented by the display, and
wherein the application framework, when executed by the processing device, is configured to cause the payment terminal to:
provide both the general purpose application and the secure payment application with access to the first frame buffer,
prevent the general purpose application from accessing the second frame buffer, and
provide the secure payment application with the ability to determine which of the first and second frame buffers is used by the display.

14. The application framework of claim 13 comprising a non-secure input module configured to handle communication with an input device configured to receive non-confidential information from a user of the payment terminal.

15. The application framework of claim 13 comprising at least one output module configured to handle communication with at least one output device, wherein the application framework, when executed by the processing device, provides both the general purpose application and the secure payment application with access to the at least one output module.

16. The application framework of claim 13 wherein the general purpose application is configured to request the secure payment application to use the first frame buffer.

17. The application framework of claim 16 wherein the application framework comprises an application interface and the general purpose application is configured to communicate with the secure payment application via the application interface.
